(19) United States
(12) Patent Application Publication
(10) Pub. No.: US 2025/0118013 A1
(43) Pub. Date: Apr. 10, 2025

(54) 3D IMAGE GENERATING METHOD, COMPUTER DEVICE AND NON-TRANSITORY STORAGE MEDIUM

(71) Applicant: FUTURE TECHNOLOGY (XIANGYANG) CO., LTD., Xiangyang City (CN)

(72) Inventors: Shu He, Xiangyang City (CN); Wanliang Xu, Xiangyang City (CN)

(21) Appl. No.: 18/987,044

(22) Filed: Dec. 19, 2024

Related U.S. Application Data
(63) Continuation of application No. PCT/CN2023/101651, filed on Jun. 21, 2023.

(30) Foreign Application Priority Data
Jun. 23, 2022 (CN) 202210724367.2

(51) Int. Cl. G06T 15/20; G06T 7/50; G06T 7/90; G06T 11/40

(52) U.S. Cl. CPC G06T 15/205; G06T 7/50; G06T 7/90; G06T 11/40; G06T 2207/10024; G06T 2207/10028

(57) ABSTRACT

A 3D image generating method includes: separating a target 2D image to obtain an initial color image and an initial depth image; associatively processing the initial color image and the initial depth image to obtain a first color image and a target depth image, the target depth image including multiple reference pixels; determining a target pixel according to a depth value of the reference pixel, the target pixel being a pixel which is a hole in the first color image; determining a hole filling value for the target pixel according to the reference pixel, performing filling and generating a target color image; and interleaving the initial color image and the target color image to generate a target 3D image. A computer device and a storage medium are also provided.

### CROSS-REFERENCE TO RELATED APPLICATION

The present application is a continuation application of International Application No. PCT/CN2023/101651, filed on Jun. 21, 2023, which claims priority to Chinese Patent Application No. 202210724367.2, filed on Jun. 23, 2022. The disclosures of the aforementioned applications are incorporated in the present application by reference in their entirety.

### TECHNICAL FIELD

The present application relates to the technical field of 3D image displaying, and in particular to a 3D image generating method, a 3D image generating device and a computer device.

### BACKGROUND

A RGBD image includes two images, one is an ordinary RGB three-channel color image, and the other is a depth image. The RGB image includes color information of graphics and the depth image includes depth information. The three-channel RGB color image can be rendered from different angles to generate new color images, and then the new color images generated from different angles are taken as the model texture to generate a three-dimensional model.

In the existing 3D image generating method, when being rendered from a certain angle, there will be some holes in the new color image. Therefore, it is necessary to provide a 3D image generating method that can fill the holes.

### SUMMARY

In order to solve the problem in the related art that the color image generated by rendering has holes, the present application provides a 3D image generating method, a 3D image generating device and a computer device that can fill the holes, so that the holes in the color image generated by rendering are filled, and a 3D image is generated based on the color image without holes.

A first aspect of the present application provides a 3D image generating method, including:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

A second aspect of the present application provides a computer device, including:
a memory storing program codes; and
a processor configured to call the program codes in the memory to execute a 3D image generating method comprising:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

A third aspect of the present application provides a non-transitory storage medium storing program codes, when the program codes are invoked by a processor, a 3D image generating method comprising operations are realized:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

Compared with the related art, the 3D image generating method provided by the present application separates a target 2D image to obtain an initial color image and an initial depth image, performs an associative processing on the initial color image and the initial depth image to obtain a first color image and a target depth image, determines a target pixel, which is a hole in the first color image according to a reference pixel in the target depth image, determines a hole filling value of the target pixel according to the reference pixel, completes the filling of holes in the first color image to obtain a target color image without holes, and interleaves the initial color image and the target color image to generate a target 3D image without holes.

### BRIEF DESCRIPTION OF THE DRAWINGS

FIG. 1 is a schematic flowchart of a 3D image generating method according to an embodiment of the present application.

FIG. 2 is a schematic flowchart of determining a first color image and a target depth image according to an embodiment of the present application.

FIG. 3 is a schematic diagram showing a relative displacement of a camera during rendering of an initial color image according to an embodiment of the present application.

FIG. 4 is a schematic diagram showing a first reference pixel and four pairs of diagonal pixels of a reference image according to an embodiment of the present application.

FIG. 5 is a schematic diagram showing a preset path according to an embodiment of the present application.

FIG. 6 is a schematic diagram of a hardware structure of a 3D image generating device according to an embodiment of the present application.

FIG. 7 is a schematic structural diagram of a computer device according to an embodiment of the present application.

FIG. 8 is a schematic flowchart of an associative processing method according to an embodiment of the present application.

FIGS. 9-10 are schematic flowcharts of determining a hole filling value of a target pixel according to embodiments of the present application.

### DETAILED DESCRIPTION OF THE EMBODIMENTS

The technical solutions in the embodiments of the present application will be clearly and completely described below. Obviously, the described embodiments are only some, and not all of the embodiments of the present application. Based on the embodiments in the present application, all other embodiments obtained by those of ordinary skill in the art without creative efforts fall within the claim of the present application.

The present application provides a 3D image generating method. The 3D image generating method provided by the present application is described below from the perspective of a 3D image generating device. The 3D image generating device can be a terminal device, such as a mobile phone, a tablet or the like, or another device such as a server or the like.

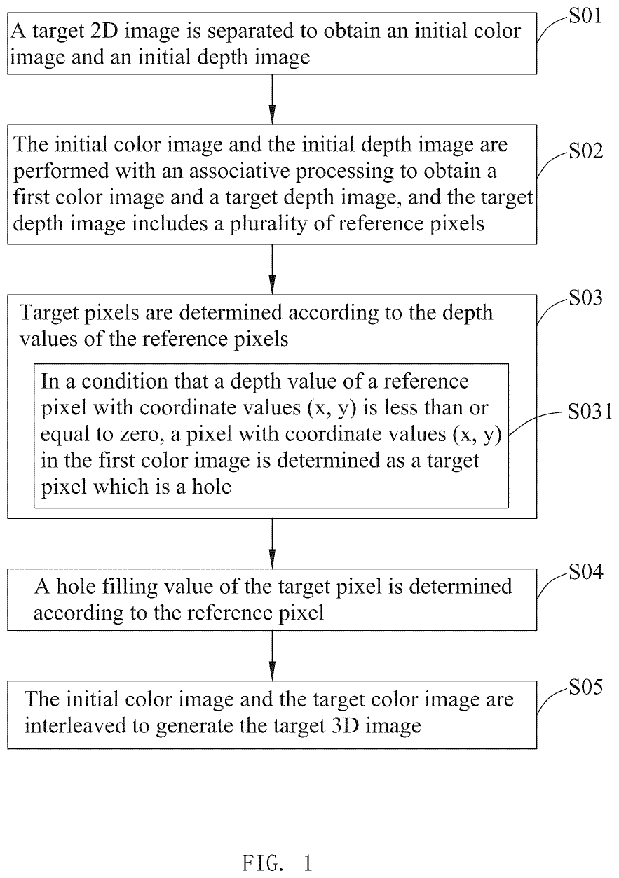

Referring to FIG. 1, FIG. 1 is a schematic flowchart of a 3D image generating method according to an embodiment of the present application. The method includes the following operations.

In operation S01, a target 2D image is separated to obtain an initial color image and an initial depth image.

In this embodiment, the 3D image generating device separates a target 2D image, from which a target 3D image is to be generated, to obtain an initial color image and an initial depth image. The target 2D image is an RGBD image including two images. One of the two images is an ordinary RGB three-channel color image including color information of graphics, and the other is a depth image including depth information. The initial color image is an RGB three-channel color image including multiple pixels. Each pixel is represented by a coordinate value (x, y) and has a pixel value which represents RGB color information. The initial depth image is a depth image and includes a plurality of pixels. The pixels of the initial depth image have coordinate values corresponding to a target depth image. Each pixel of the initial depth image has a depth value representing depth information.

In operation S02, the initial color image and the initial depth image are performed with an associative processing to obtain a first color image and a target depth image, and the target depth image includes a plurality of reference pixels.

In this embodiment, the 3D image generating device performs associative processing on the initial color image and the initial depth image to obtain a first color image and a target depth image. The target depth image includes multiple reference pixels, and each reference pixel can be any pixel in the target depth image. Two methods of associative processing are detailed below.

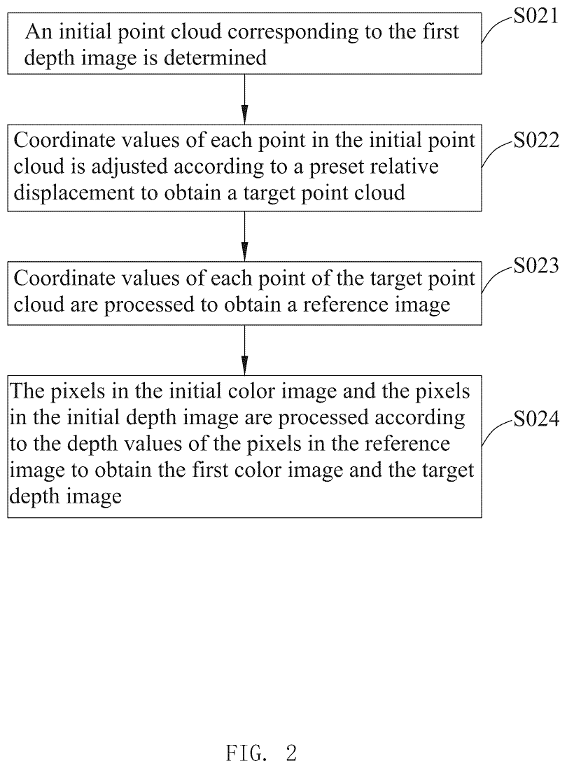

The first method of associative processing will be described below with reference to FIG. 2. FIG. 2 is a schematic flowchart for determining the first color image and the target depth image according to an embodiment of the present application, which includes the following operations.

In operation S021, an initial point cloud corresponding to the first depth image is determined.

In this embodiment, after the initial depth image is obtained, the initial depth image is remapped to be a first depth image according to a formula:

$${I}_{d 1} ( z ) = {I}_{d} ( z ) / D max * Max Depth .$$

I_{d} represents the initial depth image, I_{d1} represents the first depth image, I_{d}(Z) is a depth value of any pixel in the initial depth image, and Dmax is the maximum depth value of pixels of the initial depth image. MaxDepth is an empirical value, which can be 100 or another value, such as 80, 90 or 110, which is not specifically limited as long as it does not exceed the maximum floating-point value. The coordinate values of pixels of the first depth image obtained by remapping correspond to the coordinate values of pixels of the initial depth image one to one, I_{d1}(z) is a depth value of a pixel of the first depth image having coordinate values identical to those of I_{d}(z).

After the first depth image is obtained, the first depth image is converted into an initial point cloud according to a formula:

$$P 0 ( x , y , z ) = ( - w / 2 + x , - h / 2 + y , {I}_{d 1} ( x , y ) ) ,$$

where 0≤x<w, 0≤y<h, P0 represents the initial point cloud, P0(x, y, z) are coordinate values of any point in the initial point cloud, W represents a width of the first depth image, h represents a height of the first depth image, and I_{d1}(x, y) represents a depth value of a pixel with coordinate values (x, y) in the first depth image.

In operation S022, coordinate values of each point in the initial point cloud is adjusted according to a preset relative displacement to obtain a target point cloud.

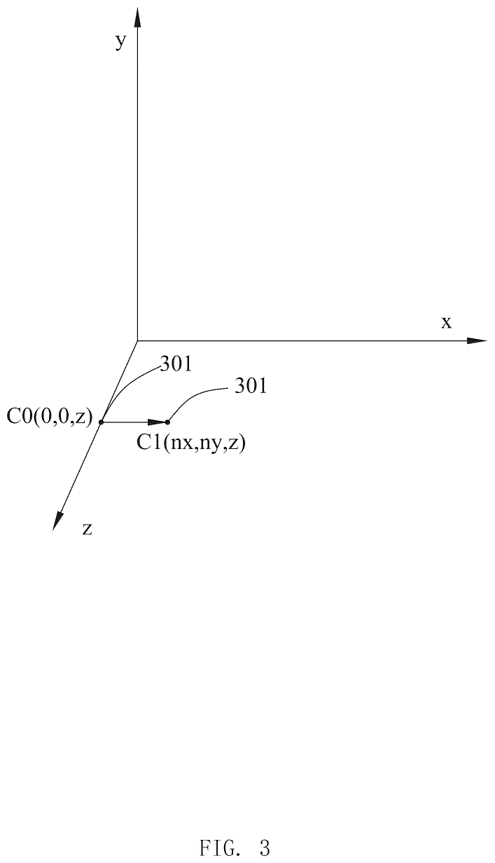

In this embodiment, the preset relative displacement is explained with reference to FIG. 3. FIG. 3 is a schematic diagram showing a relative displacement of a camera during rendering of the initial color image according to an embodiment of the present application. During the rendering of the initial color image, a coordinate point C0 is where the camera 301 was located. The camera 301 was located in a three-dimensional space defined by the x-axis, the y-axis and the z-axis, and the coordinate point C0 has coordinate values (0, 0, z). Different rendered images can be obtained by changing the location of the camera 301. The 3D display image can be generated by interleaving the different rendered images corresponding to different locations of the camera 301. However, in order to keep sizes of the different rendered images to be same, the location of the camera 301 was remained unchanged on the z-axis. The changed location of the camera 301 was at a coordinate point C1, and the coordinate point C1 has coordinate values (nx, ny, z). The difference between the two locations of the camera 301 forms the preset relative displacement, and the preset relative displacement of the camera 301 is determined according to a formula:

$$D = C 1 - C 0 = ( n x , n y , 0 ) ,$$

where D is the preset relative displacement of the camera 301.

Further, the preset relative displacement is added to the initial point cloud to obtain the target point cloud. In this embodiment, the target point cloud is determined according to a formula:

$$P 1 ( x , y , z ) = P 0 ( x , y , z ) + D .$$

where P0(x, y, z) represent the coordinate values of any point of the initial point cloud, P1 represents the target point cloud, P1(x, y, z) are the coordinate values of the point in the target point cloud. The coordinate values P1(x, y, z) of the point are obtained by adding D to the coordinate values P0(x, y, z). Since the location of the camera was remained unchanged on the z-axis and D has values (nx, ny, 0), z-values of the coordinate values of the target point cloud and the initial point cloud are the same.

In operation S023, coordinate values of each point of the target point cloud are processed to obtain a reference image.

In this embodiment, the reference image is a depth image that matches a size of the initial depth image, and is initially assigned with a depth value A. Each point of the target point cloud is calculated by the 3D image generating device according to the following formulas to obtain the reference image:

$$Z ( x , y ) = min ( Z ( IP . x + 1 , IP . y + 1 ) . FltErr ) ;$$

$$FltErr = A - w / ( 2 * z 0 ) ;$$

$$IP = LP + Dis * DLP ;$$

$$Dis = ( PP - LP ) * PN ; and$$

$$DLP = - LP ,$$

where Z is the reference image, Z(x, y) is a depth value of a pixel with coordinate values (x, y) in the reference image, Z(IP.x+1, IP.y+1) is a depth value of a pixel with coordinate values (IP.x+1, IP.y+1) in the reference image, min means to assign Z(x, y) with a smaller one of Z(IP.x+1, IP.y+1) and FltErr;
LP=(x0, y\vec{0}, z0), PN=(0, \vec{0}, 1), PP=(0, \vec{0}, w/2), A is an initial depth value of the reference image, W is the width of the first depth image, (x0, y0, z0) are coordinate values of any point in the target point cloud, IP.x is the x-value of the coordinate values of the point IP, and IP.y is the y-value of the coordinate values of the point IP.

The reference image is a depth image with the same size as the first depth image. A width of the reference image is same to the width of the first depth image, and a height of the reference image is same to the height of the first depth image. The initial depth value of the reference image is A. The initial depth value A can be 100000.0, 90000.0, or 110000.0 which is not specifically limited as long as the initial depth value A is greater than the depth value of the first depth image and less than the maximum floating-point value.

It should be noted that after the reference image is determined, the depth value of each pixel in the reference image can be optimized according to the following operations, such that the target 3D image, which is finally generated, is optimized.

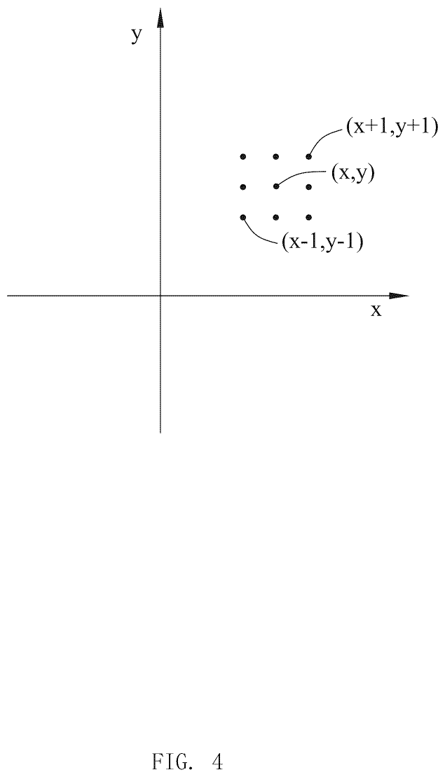

The optimization of the pixels of the reference image will be described in detail below with reference to FIG. 4. FIG. 4 is a schematic diagram showing a first reference pixel and four pairs of adjacent pixels of the reference image according to an embodiment of the present application.

The first reference pixel is determined, and the first reference pixel is a pixel of the reference image whose depth value is to be optimized. If a depth value of the first reference pixel is greater than depth values of the four pairs of adjacent pixels, the depth value of the first reference pixel is changed to be equal to an average of the depth values of the four pairs of adjacent pixels.

It can be understood that the first reference pixel can be any pixel in the reference image, and the optimization process is described by taking coordinate values of the first reference as (x, y). The coordinate values of the four pairs of adjacent pixels are a pair of adjacent pixels including an upper pixel and a lower pixel, a pair of adjacent pixels including a left pixel and a right pixel of the first reference pixel, and two pairs of diagonal pixels including a left-lower pixel, a right-upper pixel, a right-lower pixel and a left-upper pixel (as shown in FIG. 4). Coordinate values of the upper pixel are (x, y+1), coordinate values of the lower pixel are (x, y−1), coordinate values of the left pixel are (x−1, y), and coordinate values of the right pixel are (x+1, y). Coordinate values of the two pairs of diagonal pixels are (x−1, y−1), (x+1, y+1), (x+1, y−1) and (x−1, y+1).

The optimization method of the first reference pixel will be described below with reference to FIG. 4.

Generally, in responding to that the depth value of the first reference pixel meets conditions of Z(x, y)>Z(x−1, y) and Z(x, y)>Z(x+1, y), that is, in a condition that the depth value of the first reference pixel is greater than depth values of the left pixel and the right pixel,
Zsum=Zsum+Z(x−1, y)+Z(x+1, y), and Ztol=Ztol+2 are applied.

In responding to that the depth value of the first reference pixel meets conditions of Z(x, y)>Z(x, y−1) and Z(x, y)>Z(x, y+1), that is, in a condition that the depth value of the first reference pixel is greater than depth values of the lower pixel and the upper pixel,
Zsum=Zsum+Z(x, y−1)+Z(x, y+1) and Ztol=Ztol+2 are applied.

In responding to that the depth value of the first reference pixel meets conditions of Z(x, y)>Z(x−1, y−1) and Z(x, y)>Z(x+1, y+1), that is, in a condition that the depth value of the first reference pixel is greater than depth values of a left-lower pixel and a right-upper pixel, Zsum=Zsum+Z(x−1, y−1)+Z(x+1, y+1) and Ztol=Ztol+2 are applied.

In responding to that the depth value of the first reference pixel meets conditions of Z(x, y)>Z(x+1, y−1), and Z(x, y)>Z(x−1, y+1), that is, in a condition that the depth value of the first reference pixel is greater than depth values of a right-lower pixel and a left-upper pixel, Zsum=Zsum+Z(x+1, y−1)+Z(x−1, y+1) and Ztol=Ztol+2 are applied.

Finally, an average value is calculated according to a formula:

$$Z ( x , y ) = Zsum / Ztol ,$$

where values of Zsum and Ztol are initially 0. In a condition that the depth value of the first reference pixel with coordinate values (x, y) is greater than the depth values of the four pairs of adjacent pixels, a new depth value is obtained and the initial depth value of the first reference pixel is replaced by the new depth value.

Z(x, y) is the depth value of the first reference pixel in the reference image, Z(x+1, y) is a depth value of a pixel with coordinate values (x+1, y) in the reference image, Z(x−1, y) is a depth value of a pixel with coordinate values (x−1, y) in the reference image, Z(x, y−1) is a depth value of a pixel with coordinate values (x, y−1) in the reference image, Z(x, y+1) is a depth value of a pixel with coordinate values (x, y+1) in the reference image, Z(x+1, y+1) is a depth value of a pixel with coordinate values (x+1, y+1) in the reference image, Z(x−1, y−1) is a depth value of a pixel with coordinate values (x−1, y−1) in the reference image, Z(x−1, y+1) is a depth value of a pixel with coordinate values (x−1, y+1) in the reference image, Z(x+1, y−1) is a depth value of a pixel with coordinate values (x+1, y−1) in the reference image.

It should be noted that the optimization method of the first reference pixel described above is utilized to determine whether the depth value of the first reference pixel is greater than the depth values of its four pairs of adjacent pixels, obtain the average value of the four pairs of adjacent pixels when the depth value of the first reference pixel is greater than the depth values of the four pairs of adjacent pixels, and updates the depth value of the first reference pixel with the average value.

In operation S024, the pixels in the initial color image and the pixels in the initial depth image are processed according to the depth values of the pixels in the reference image to obtain the first color image and the target depth image.

In this embodiment, the first color image is determined according to the following formula:

$${I}_{c 1} ( IP . x , IP . y ) = {I}_{c} ( x , y ) * ( ( Z ( x , y ) + 1 ) > FltErr ) ,$$

where I_{c} is the initial color image, I_{c1} is the first color image, IP.x is the x-value of the coordinate values of the point IP, IP.y is the y-value of the coordinate values of the point IP, I_{c}(x, y) is a pixel value of a pixel with coordinate values (x, y) in the initial color image, and Z(x, y) is a depth value of a pixel with coordinate values (x, y) in the reference image. I_{c1}(IP.x, IP.y) is the pixel value of the pixel with coordinate values (IP.x, IP.y) in the first color image.

In a condition that (Z(x, y)+1)>FltErr is met, ((Z(x, y)+1)>FltErr) is 1, then the pixel with coordinate values (IP.x, IP.y) in the first color image is assigned with the pixel value of the pixel with coordinate values (x, y) in the initial depth image.

In a condition that (Z(x, y)+1)>FltErr is not met, ((Z(x, y)+1)>FltErr) is 0, then the pixel value of the pixel with coordinate values (IP.x, IP.y) in the first color image is assigned with 0.

The target depth image is determined according to the following formula:

$${I}_{d 2} ( IP . x , IP . y ) = {I}_{d} ( x , y ) * ( ( Z ( x , y ) + 1 ) > FltErr ) ;$$

where I_{d} represents the initial depth image, I_{d2} represents the target depth image, I_{d}(x, y) is the depth value of the pixel with coordinate values (x, y) in the initial depth image, I_{d2}(IP.x, IP.y) is a depth value of the pixel with coordinate values (IP.x, IP.y) in the target depth image. In a condition that ((Z(x, y)+1)>FltErr) is 1, the pixel with coordinate values (IP.x, IP.y) in the target depth image is assigned with the depth value of the pixel with coordinate values (x, y) in the initial depth image. In a condition that ((Z(x, y)+1)>FltErr) is 0, the depth value of the pixel with the coordinate values (IP.x, IP.y) in the target depth image is assigned with a value of 0.

In this method, associative processing are performed on the initial color image and the initial depth image through the initial point cloud, the target point cloud and the reference image, and resulted pixel values of the pixels in the first color image are associative with the depth values of the pixels in the target depth image.

The second associative processing method is explained below. The second associative processing method includes the following operations.

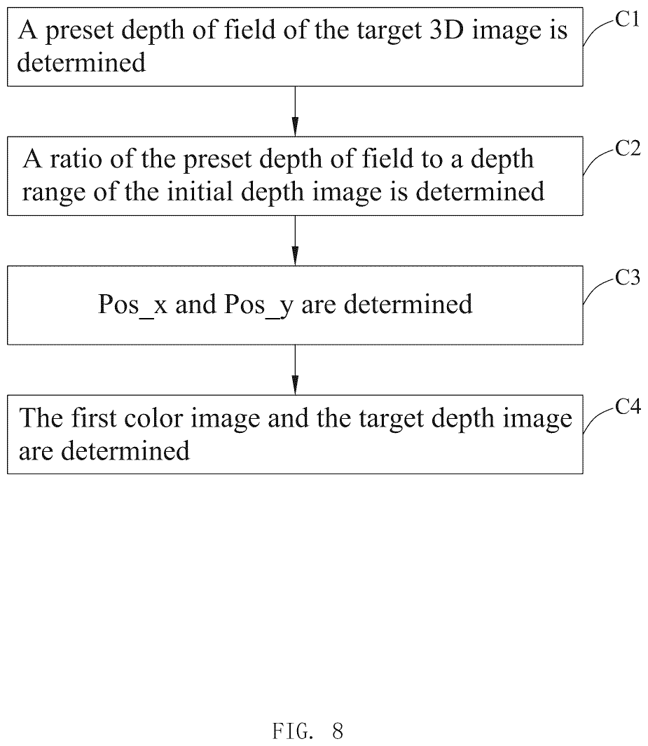

Referring to FIG. 8, in operation C1, a preset depth of field of the target 3D image is determined. The preset depth of field of the target 3D image on the x-axis is nx0 to nx1, and the preset depth of field on the y-axis is ny0 to ny1.

In this embodiment, the preset depth of field is a preset parallax, which is a certain number in units of pixel. The x-axis is parallel to the width of the 3D image, and the y-axis is parallel to the height of the 3D image. For example, the preset depth of field of the target 3D image on the x-axis is 10 to 100 pixel units, then nx0 is 10 pixel units and nx1 is 100 pixel units. The preset depth of field can be 0 pixel unit. For example, if the target 3D image has no parallax on the y-axis and the preset depth of field is 0 pixel unit, ny0 is 0 pixel unit and ny1 is 0 pixel unit.

In operation C2, a ratio of the preset depth of field to a depth range of the initial depth image is determined according to formulas:

$$DepthRateX = ( nx 1 - nx 0 ) / ( Dmax - Dmin ) , and$$

$$DepthRateY = ( ny 1 - ny 0 ) / ( Dmax - Dmin ) ,$$

where DepthRateX is a ratio of the preset depth of field to the depth range of the initial depth image on the x-axis, DepthRateY is a ratio of the preset depth of field to the depth range of the initial depth image on the y-axis, and Dmax is the maximum depth value and D min is the minimum depth value of the initial depth image.

In operation C3, Pos_x and Pos_y are determined according to formulas:

$$Pos\_x = x + ( {I}_{d} ( x , y ) - Dmin ) * DepthRateX + nx 0 ; and$$

$$Pos\_y = y + ( {I}_{d} ( x , y ) - Dmin ) * DepthRateY + ny 0 ,$$

where I_{d} is the initial depth image, I_{d}(x, y) is the depth value of the pixel with coordinate values (x, y) in the initial depth image, x is an x-value of the coordinate values of the pixel with coordinate values (x, y), and y is a y value of the coordinate values of the pixel with coordinate values (x, y).

In operation C4, the first color image and the target depth image are determined according to formulas:

$${I}_{c 1} ( Pos\_x , Pos\_y ) = {I}_{c} ( x , y ) , and$$

$${I}_{d 2} ( Pos\_x , Pos\_y ) = {I}_{d} ( x , y ) ,$$

where I_{c} is the initial color image, I_{c1} is the first color image, I_{c}(x, y) is the pixel value of the pixel with coordinate values (x, y) in the initial color image, I_{c1}(Pos_x, Pos_y) is a pixel value of a pixel with coordinate values (Pos_x, Pos_y) in the first color image, I_{d} is the initial depth image, I_{d2} is the target depth image, and I_{d2}(Pos_x, Pos_y) is a depth value of the pixel with coordinate values (Pos_x, Pos_y) in the target depth image. The above formula is to assign the pixel value of the pixel with coordinate values (x, y) in the initial color image to the pixel with coordinate values (Pos_x, Pos_y) in the first color image, and assign the depth value of the pixel with the coordinate values (x, y) in the initial depth image to the pixel with the coordinate values (Pos_x, Pos_y) in the target depth image.

This method carries out the associative processing of the initial color image and the initial depth map through Pos_x and Pos_y, and associates an offset of the first color image relative to the initial color image with the depth value of the first depth image. When the depth value of the initial depth image is larger, an offset of the pixel with coordinate values (Pos_x, Pos_y) in the first depth image relative to the pixel with coordinate values (x, y) in the initial depth image is larger too. The pixel values of the pixels in the first color image obtained by this method are associated with the depth values of the pixels in the target depth image. The target depth image includes a plurality of reference pixels.

In operation S03, target pixels are determined according to the depth values of the reference pixels.

In this embodiment, after the first color image and the target depth image are determined, the 3D image generating device determines whether a pixel of the first color image is a hole based on a depth value of a reference pixel. Coordinate values of the pixel of the target color image is the same as coordinate values of the reference pixel. Pixels that are holes in the target color image are determined as target pixels.

The determining of a target pixel in the target color image is detailed below.

In operation S031, in a condition that I_{d2}(x, y)≤0 is met, the pixel with coordinate values (x, y) in the first color image is determined as the target pixel which is a hole, where I_{d2} represents the target depth image, I_{d2}(x, y) is a depth value of a reference pixel with coordinate values (x, y) in the target depth image. That is, in a condition that I_{d2}(x, y)≤0 is met, the pixel value of the pixel with coordinate values (x, y) in the first color image is 0, and for the color value is zero, the pixel is a hole. That is, in operation S031, in a condition that a depth value of a reference pixel with coordinate values (x, y) is less than or equal to zero, a pixel with coordinate values (x, y) in the first color image is determined as a target pixel which is a hole.

In operation S04, a hole filling value of the target pixel is determined according to the reference pixel.

In an embodiment, after the target pixel, which is a hole, in the first color image is determined, the 3D image generating device determines the hole filling value of the target value according to the coordinate values and a pixel value of the reference pixel, and fills the hole of the first color image according to the hole filling value to generate the target color image.

How to determine the hole filling value of the target pixel is described below, which includes the following operations.

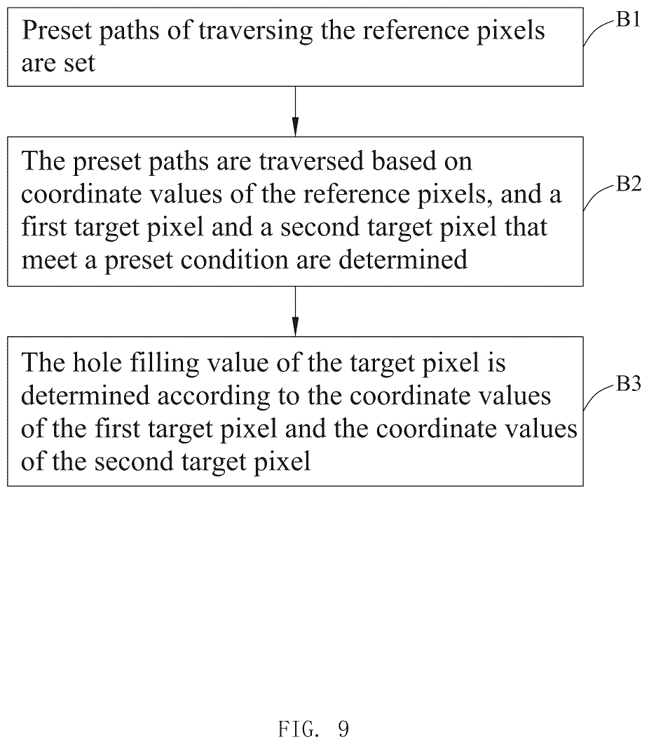

Referring to FIG. 9, in operation B1, preset paths of traversing the reference pixels are set.

In this embodiment, the preset paths can be set according to the actual situation. For example, the preset paths can be 16, 6, or 5, which are not specifically limited. The preset paths can be determined based on the generating of the target 3D image.

16 preset paths are taken as examples to detail the traversal method.

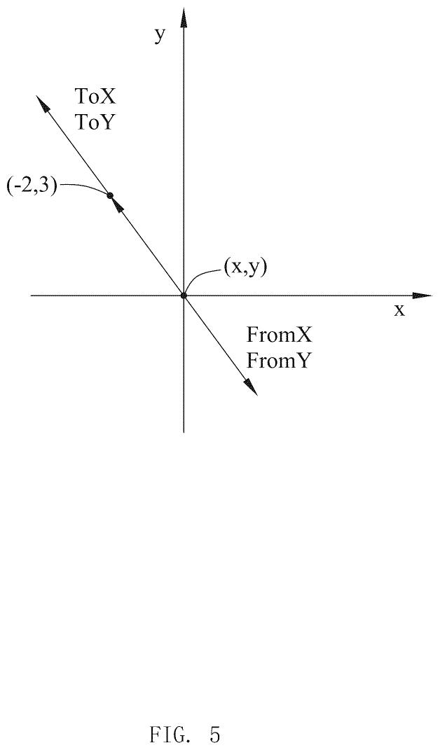

The preset paths are represented by Dirs, and there are 16 preset search directions for traversal, that is, Dirs=(−1, 1), (0, 1), (1, 1), (1, 0), (−1, 2), (1, 2), (2, 1), (2, −1), (−2, 3), (−1, 3), (1, 3), (2, 3), (3, 2), (3, 1), (3, −1), (3, −2). Referring to FIG. 5, FIG. 5 is a schematic diagram showing a preset path according to an embodiment of the present application. The preset path shown in FIG. 5 is Dirs=(−2, 3).

In operation B2, the preset paths are traversed based on coordinate values of the reference pixels, and a first target pixel and a second target pixel that meet a preset condition are determined.

The operations of traversing the reference pixels will be described below with reference to FIG. 5. Taking the reference pixel with coordinate values (x, y) as a starting point, and the traversal is performed in each of the preset directions according to the following operations.

Generally, negative direction traversal is performed according to formulas:

$$From X = F r o m X - D i r s [ i ] [ 0 ] , and$$

$$FromY = Fro m Y - D i r s [ i ] [ 1 ] .$$

The negative direction traversal is performed until I_{d2}(FromX, FromY)>0 is met or one of FromX and FromY exceeds the boundary of the target depth image.

[i] in Dirs[i][0] and Dirs[i][1] represents the preset path to be traversed, and [0] means that a value of Dirs[i][0] is equal to a left one of coordinate values of the preset path. [1] means that a value of Dirs[i][1] is equal to a right one of the coordinate values of the preset path. For example, the preset path is Dirs=(−2, 3), when coordinate values (−2, 3) is used as the preset direction for the negative direction traversal (as shown in FIG. 5), the left one of the coordinate values is −2, the right one of the coordinate values is 3, and FromX=FromX−(−2) and FromY=FromY−3 are determined.

Positive direction traversal is performed according to formulas:

$$ToX = ToX + Dirs [ i ] [ 0 ] , and$$

$$ToY = ToY + Dirs [ i ] [ 1 ] .$$

The positive direction traversal is performed until I_{d2}(ToX, ToY)>0 is met or one of ToX and ToY exceeds the boundary of the target depth image.

[i] in Dirs[i][0] and Dirs[i][1] represents the preset path to be traversed, and [0] means that the value of Dirs[i][0] is equal to a left one of coordinate values of the preset path. [1] means that a value of Dirs[i][1] is equal to a right one of the coordinate values of the preset path. For example, the preset path is Dirs=(−2, 3), when coordinate values (−2, 3) is used as the preset direction for the positive direction traversal (as shown in FIG. 5), the left one of the coordinate values is −2, the right one of the coordinate values is 3, and ToX=ToX+(−2) and ToY=ToY+3 are determined.

Whether FromX, FromY, ToX and ToY exceed the boundary of the target depth image is determined. In a condition that one of them exceeds the boundary, a formula as follows is applied:

$$FltDis = FLOAT\_MAX .$$

In a condition that FromX, FromY, ToX and ToY do not exceed the boundary of the target depth image, a formula as follows is applied:

$$FltDis = \sqrt{{( ToX - FromY )}^{2} + {( ToY - FromX )}^{2}} .$$

FLOAT_MAX is the maximum floating-point value.

After all 16 preset paths are traversed, values of FromX, FromY, ToX and ToY, which result in the minimum value of FltDis, are determined, and a combination of (FromX, FromY) are taken as the coordinate values of the first target pixel of the target depth image, and a combination of (ToX, ToY) are taken as the coordinate values of the second target pixel of the target depth image.

It should be noted that the negative direction traversal and the positive direction traversal are employed to determine the values of FromX, FromY, ToX and ToY of traversing the preset paths. However, the executing of the negative direction traversal and the positive direction traversal is not limited to a fixed order. The negative direction traversal can be executed first or the positive direction traversal can be executed first which is not specifically limited here.

In operation B3, the hole filling value of the target pixel is determined according to the coordinate values of the first target pixel and the coordinate values of the second target pixel.

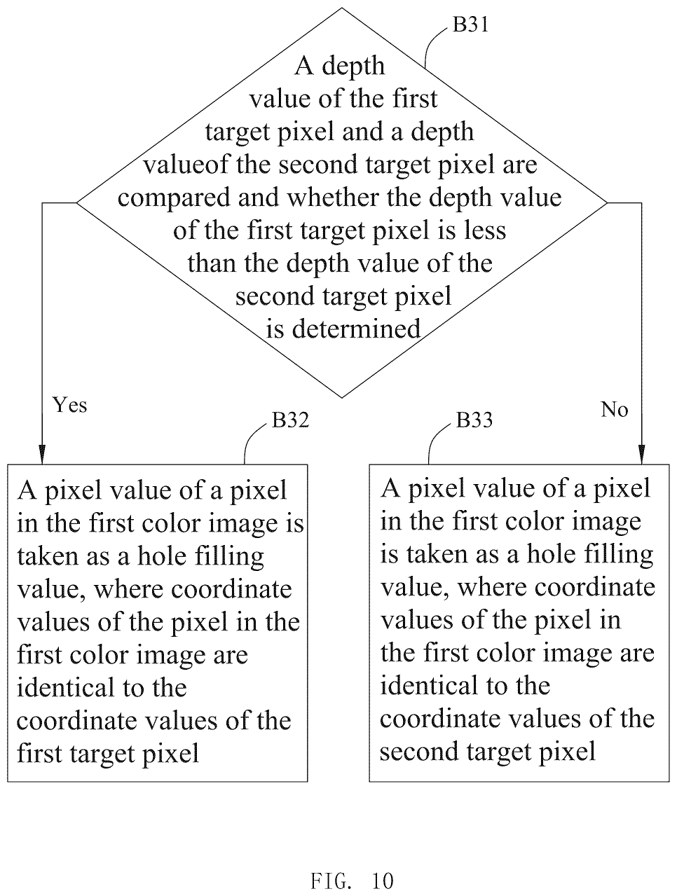

In this embodiment, referring to FIG. 10, in operation B31, a depth value of the first target pixel and a depth value of the second target pixel are compared and whether the depth value of the first target pixel is less than the depth value of the second target pixel is determined. In operation B32, in responding to that the depth value of the first target pixel is less than the depth value of the second target pixel, a pixel value of a pixel in the first color image is taken as a hole filling value, where coordinate values of the pixel in the first color image are identical to the coordinate values of the first target pixel. That is, in a condition that a relationship of the depth values of the first target pixel and the second target pixel is I_{d2}(FromX, FromY)<I_{d2}(ToX, ToY), FillX=FromX and FillY=FromY are determined. In operation B33, in responding to that the depth value of the first target pixel is greater than or equal to the depth value of the second target pixel, a pixel value of a pixel in the first color image is taken as a hole filling value, where coordinate values of the pixel in the first color image are identical to the coordinate values of the second target pixel. That is, in a condition that the relationship of the depth values of the first target pixel and the second target pixel is I_{d2}(FromX, FromY)≥I_{d2}(ToX, ToY), FillX=ToX and FillY=ToY are determined.

I_{d2}(FromX, FromY) is the depth value of the first target pixel, and I_{d2}(ToX, ToY) is the depth value of the second target pixel.

The hole filling value is determined according to a formula:

$${I}_{c 1} ( x , y ) = {I}_{c 1} ( FillX , FillY ) ,$$

where I_{c1} represents the first color image, (x, y) is the coordinate values of the target pixel, I_{c1}(x, y) is the hole filling value of the target pixel, I_{c1}(FillX, FillY) is the pixel value of the pixel with coordinate values (FillX, FillY) in the first color image. The pixel value of the pixel with coordinate values (FillX, FillY) in the first color image is determined as the hole filling value according to the formula.

The hole filling value is assigned to the target pixel to fill the hole in the target color image, and the target color image without holes is obtained.

In operation S05, the initial color image and the target color image are interleaved to generate the target 3D image.

In this embodiment, the 3D image generating device interleaves the initial color image and the target color image without holes to generate the target 3D image.

Compared with the related art, the 3D image generating method provided by the present application separates a target 2D image to obtain an initial color image and an initial depth image, performs an associative processing on the initial color image and the initial depth image to obtain a first color image and a target depth image, determines a target pixel, which is a hole in the first color image according to a reference pixel in the target depth image, determines a hole filling value of the target pixel according to the reference pixel, completes the filling of holes in the first color image to obtain a target color image without holes, and interleaves the initial color image and the target color image to generate a target 3D image without holes.

The present application is described above from the perspective of the 3D image generating method, and the present application is described below from the perspective of the 3D image generating device.

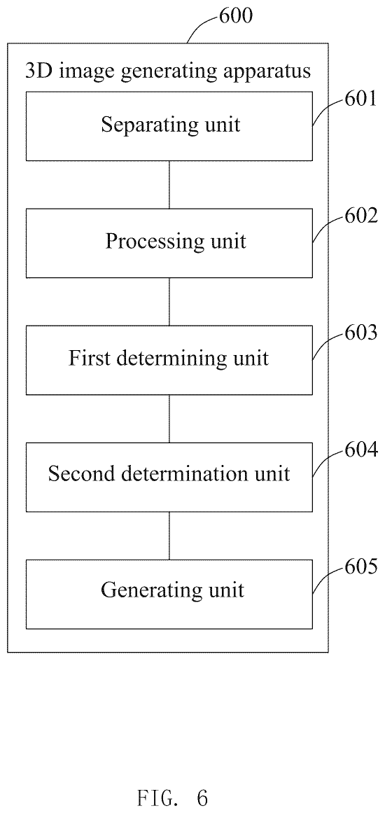

Referring to FIG. 6, FIG. 6 is a schematic diagram of hardware structure of a 3D image generating device according to an embodiment of the present application. The 3D image generating apparatus 600 includes:
a separating unit 601 configured to separate a target 2D image to obtain an initial color image and an initial depth image;
a processing unit 602 configured to perform an associative processing on the initial color image and the initial depth image to obtain a first color image and a target depth image, the target depth image including a plurality of reference pixels;
a first determining unit 603 configured to determine target pixels according to depth values of the reference pixels, where the target pixels are pixels that are holes in the first color image;
a second determination unit 604 configured to determine hole filling values of the target pixels according to the reference pixels, fill the target pixels, and generates a target color image, the target color image being obtained by filling the holes in the first color image;
a generating unit 605 configured to interleave the initial color image and the target color image to generate a target 3D image.

In an embodiment, the second determining unit 604 is further configured to:
set preset paths of traversing the reference pixels, where the preset paths are set in the target depth image;
traverse the preset paths based on coordinate values of the reference pixels, and determine a first target pixel and a second target pixel that meet a preset condition;
determine the hole filling values according to coordinate values of the first target pixel and coordinate values of the second target pixel.

In an embodiment, the second determining unit 604 is further configured to:
in responding to that a depth value of the first target pixel is less than a depth value of the second target pixel, taking a pixel value of a pixel in the first color image as a hole filling value, where coordinate values of the pixel in the first color image are the same as the coordinate values of the first target pixel; or
in responding to that the depth value of the first target pixel is greater than or equal to the depth value of the second target pixel, take a pixel value of a pixel in the first color image as a hole filling value, where coordinate values of the pixel in the first color image are the same as the coordinate values of the second target pixel.

In an embodiment, the first determining unit 603 is further configured to:
in a condition that I_{d2}(x, y)≤0 is met, determine that a pixel with coordinate values (x, y) in the first color image is a target pixel which is a hole, where I_{d2} is the target depth image, I_{d2}(x, y) is a depth value of a reference pixel with coordinate values (x, y) in the target depth image.

In an embodiment, the processing unit 602 is further configured to:
determine an initial point cloud corresponding to a first depth image, where the first depth image is obtained by remapping of the initial depth image;
adjust coordinate values of each point in the initial point cloud according to a preset relative displacement to obtain a target point cloud;
process coordinate values of each point in the target point cloud to obtain a reference image, where the reference image is a depth image that matches a size of the initial depth image;
process pixels in the initial color image and pixels in the initial depth image according to depth values of pixels in the reference image to obtain the first color image and the target depth image.

In an embodiment, the processing unit 602 is further configured to:
determine the reference image according to the following formulas:

$$Z ( x , y ) = min ( Z ( IP . x + 1 , IP . y + 1 ) , FltErr ) ;$$

$$FltErr = A - w / ( 2 * z 0 ) ;$$

$$IP = LP + Dis * DLP ;$$

$$Dis = ( PP - LP ) * PN ; and$$

$$DLP = - LP ,$$

where Z is the reference image, Z(x, y) is a depth value of a pixel with coordinate values (x, y) in the reference image, Z(IP.x+1, IP.y+1) is a depth value of a pixel with coordinate values (IP.x+1, IP.y+1) in the reference image, and min means to assign Z(x, y) with a smaller one of Z(IP.x+1, IP.y+1) and FltErr;
LP=(x0, y\vec{0}, z0), PN=(0, \vec{0}, 1), 1 PP=(0, \vec{0}, w/2), A is an initial depth value of the reference image, W is a width of the first depth image, (x0, y0, z0) are coordinate values of any point in the target point cloud, IP.x is an x-value of coordinate values of a point IP, and IP.y is a y-value of the coordinate values of the point IP.

In an embodiment, the processing unit 602 is further configured to:
process the initial color image to obtain the first color image according to the following formula:

$${I}_{c 1} ( IP . x , IP . y ) = {I}_{c} ( x , y ) * ( ( Z ( x , y ) + 1 ) > FltErr ) ,$$

where I_{c} is the initial color image, I_{c1} is the first color image, I_{c}(x, y) is a pixel value of a pixel with coordinate values (x, y) in the initial color image, and Z(x, y) is a depth value of a pixel with coordinate values (x, y) in the reference image, I_{c1}(IP.x, IP.y) is a pixel value of a pixel with coordinate values (IP.x, IP.y) in the first color image;
process the initial depth image to obtain the target depth image according to the following formula:

$${I}_{d 2} ( IP . x , IP . y ) = {I}_{d} ( x , y ) * ( ( Z ( x , y ) + 1 ) > FltErr ) ,$$

where I_{d} represents the initial depth image, I_{d2} represents the target depth image, I_{d}(x, y) is a depth value of a pixel with coordinate values (x, y) in the initial depth image, I_{d2}(IP.x, IP.y) is a depth value of a pixel with coordinate values (IP.x, IP.y) in the target depth image.

In an embodiment, the processing unit 602 is further configured to:
determine a preset depth of field of the target 3D image, the preset depth of field of the target 3D image on an x-axis being nx0 to nx1, and the preset depth of field on the y-axis being ny0 to ny1;
determine a ratio of the preset depth of field to a depth range of the initial depth image according to the following formulas:

$$\begin{matrix}DepthRateX = ( nx 1 - nx 0 ) / ( D max - D min ) , and \\ DepthRateY = ( ny 1 - ny 0 ) / ( D max - D min ) .\end{matrix}$$

where DepthRateX is a ratio of the preset depth of field to the depth range of the initial depth image on the x-axis, DepthRateY is a ratio of the preset depth of field to the depth range of the initial depth image on the y-axis, and Dmax is the maximum depth value and D min is the minimum depth value of the initial depth image;
determine Pos_x and Pos_y according to the following formulas:

$$\begin{matrix}Pos\_x = x + ( {I}_{d} ( x , y ) - D min ) * DepthRateX + nx 0 , \\ Pos\_y = y + ( {I}_{d} ( x , y ) - D min ) * DepthRateY + ny 0 ;\end{matrix}$$

determine the first color image and the target depth image according to the following formulas:

$$\begin{matrix}{I}_{c 1} ( Pos\_x , Pos\_y ) = {I}_{c} ( x , y ) , and \\ {I}_{d 2} ( Pos\_x , Pos\_y ) = {I}_{d} ( x , y ) ,\end{matrix}$$

where I_{c} is the initial color image, I_{c1} is the first color image, I_{c}(x, y) is the pixel value of the pixel with coordinate values (x, y) in the initial color image, I_{c1}(Pos_x, Pos_y) is a pixel value of a pixel with coordinate values (Pos_x, Pos_y) in the first color image, I_{d} is the initial depth image, I_{d2} is the target depth image, and I_{d2}(Pos_x, Pos_y) is a depth value of the pixel with coordinate values (Pos_x, Pos_y) in the target depth image.

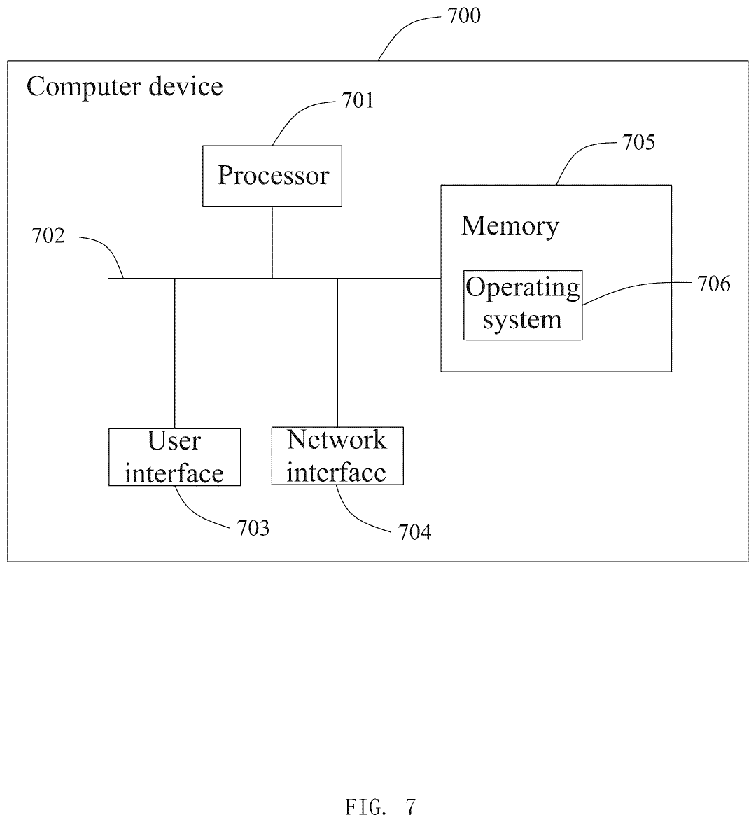

Referring to FIG. 7, FIG. 7 is a schematic structural diagram of a computer device of the present application. The computer device 700 in this embodiment includes at least one processor 701, at least one network interface 704 or another user interface 703, a memory 705, and at least one communication bus 702. The computer device 600 optionally includes the user interface 703, which can be a display, a keyboard, or a pointing device. The memory 705 may be a high-speed RAM memory, or may be a non-volatile memory, such as at least one disk memory. The memory 705 stores executable instructions. When the computer device 700 is running, the processor 701 communicates with the memory 705, and the processor 701 invokes the instructions stored in the memory 705 to execute the above-mentioned 3D image generating method. The operating system 706 includes various programs for implementing various basic tasks and processing hardware-based tasks.

The computer device provided by the embodiment of the present application can execute the above-mentioned embodiments of the 3D image generating method. The implementation principles and technical effects are similar to the above and will not be repeated here.

Embodiments of the present application also provide a computer-readable medium that stores computer-executable instructions. The computer-executable instructions enable a processor to execute the 3D image generating method described in the above embodiments. The implementation principles and technical effects are similar to the above and will not be described again here.

Persons of ordinary skill in the art can understand that all or part of the operations of the embodiments of the above method can be implemented by hardware related to program instructions. The aforementioned program instructions can be stored in a computer-readable storage medium. When the program instructions are executed, the operations including the embodiments of the above-mentioned method are executed. The aforementioned storage media can be a ROM, a RAM, a magnetic disk, an optical disks or another medium that can store program codes.

The above are only some of the embodiments of the present application, and are not intended to limit the scope of the present application. Any equivalent structure or equivalent process transformation made based on the description and drawings of the present application, and any direct or indirect utilization in another related technical field are all equally included in the scope of the present application.

What is claimed is:

1. A 3D image generating method, comprising:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

2. The method according to claim 1, wherein the determining the hole filling values of the target pixels according to the reference pixels comprises:
setting preset paths of traversing the reference pixels, wherein the preset paths are set in the target depth image;
traversing the preset paths based on coordinate values of the reference pixels, and determining a first target pixel and a second target pixel that meet a preset condition; and
determining the hole filling values according to coordinate values of the first target pixel and coordinate values of the second target pixel.

3. The method according to claim 2, wherein the determining the hole filling values according to the coordinate values of the first target pixel and the coordinate values of the second target pixel comprises:
in responding to that a depth value of the first target pixel is less than a depth value of the second target pixel, taking a pixel value of a pixel in the first color image as a hole filling value, wherein coordinate values of the pixel in the first color image are same as the coordinate values of the first target pixel; or
in responding to that a depth value of the first target pixel is greater than or equal to a depth value of the second target pixel, taking a pixel value of a pixel in the first color image as a hole filling value, wherein coordinate values of the pixel in the first color image are same as the coordinate values of the second target pixel.

4. The method according to claim 1, wherein the determining the target pixels according to the depth values of the reference pixels comprises:
in a condition that I_{d2}(x, y)≤0 is met, determining that a pixel with coordinate values (x, y) in the first color image is a target pixel which is a hole, wherein I_{d2} is the target depth image, I_{d2}(x, y) is a depth value of a reference pixel with coordinate values (x, y) in the target depth image.

5. The method according to claim 1, wherein the performing associative processing on the initial color image and the initial depth image to obtain the first color image and the target depth image comprises:
determining an initial point cloud corresponding to a first depth image, wherein the first depth image is obtained by remapping of the initial depth image;
adjusting coordinate values of each point in the initial point cloud according to a preset relative displacement to obtain a target point cloud;
processing coordinate values of each point in the target point cloud to obtain a reference image, wherein the reference image is a depth image that matches a size of the initial depth image;
processing pixels in the initial color image and pixels in the initial depth image according to depth values of pixels in the reference image to obtain the first color image and the target depth image.

6. The method according to claim 5, wherein the reference image are determined according to formulas:
$$\begin{matrix}Z ( x , y ) = min ( Z ( IP . x + 1 , IP . y + 1 ) , FltErr ) ; \\ FltErr = A - w / ( 2 * z 0 ) ; \\ IP = LP + Dis * DLP ; \\ Dis = ( PP - LP ) * PN ; and \\ DLP = - LP ,\end{matrix}$$
wherein Z is the reference image, Z(x, y) is a depth value of a pixel with coordinate values (x, y) in the reference image, Z(IP.x+1, IP.y+1) is a depth value of a pixel with coordinate values (IP.x+1, IP.y+1) in the reference image, and min means to assign Z(x, y) with a smaller one of Z(IP.x+1, IP.y+1) and FltErr,
LP=(x0, y\vec{0}, z0), PN=(0, \vec{0}, 1), PP=(0, \vec{0}, w/2), A is an initial depth value of the reference image, W is a width of the first depth image, (x0, y0, z0) are coordinate values of any point in the target point cloud, IP.x is an x-value of coordinate values of a point IP, and IP.y is a y-value of the coordinate values of the point IP.

7. The method according to claim 6, wherein the initial color image is processed to obtain the first color image according to a formula:
$${I}_{c 1} ( IP . x , IP . y ) = {I}_{c} ( x , y ) * ( ( Z ( x , y ) + 1 ) > FltErr ) ,$$
wherein I_{c} is the initial color image, I_{c1} is the first color image, I_{c}(x, y) is a pixel value of a pixel with coordinate values (x, y) in the initial color image, and Z(x, y) is the depth value of the pixel with the coordinate values (x, y) in the reference image. I_{c1}(IP.x, IP.y) is a pixel value of a pixel with coordinate values (IP.x, IP.y) in the first color image; and
the initial depth image is processed to obtain the target depth image according to a formula:
$${I}_{d 2} ( IP . x , IP . y ) = {I}_{d} ( x , y ) * ( ( Z ( x , y ) + 1 ) > FltErr ) ,$$
wherein I_{d} represents the initial depth image, I_{d2} represents the target depth image, I_{d}(x, y) is a depth value of a pixel with coordinate values (x, y) in the initial depth image, I_{d2}(IP.x, IP.y) is a depth value of a pixel with coordinate values (IP.x, IP.y) in the target depth image.

8. The method according to claim 1, wherein the performing associative processing on the initial color image and the initial depth image to obtain a first color image and a target depth image, wherein the target depth image comprises a plurality of reference pixels comprises:
determining a preset depth of field of the target 3D image, the preset depth of field of the target 3D image on an x-axis being nx0 to nx1, and the preset depth of field on the y-axis being ny0 to ny1;
determining a ratio of the preset depth of field to a depth range of the initial depth image according to formulas:
$$\begin{matrix}DepthRateX = ( nx 1 - nx 0 ) / ( D max - D min ) , and \\ DepthRateY = ( ny 1 - ny 0 ) / ( D max - D min ) ,\end{matrix}$$
wherein DepthRateX is a ratio of the preset depth of field to the depth range of the initial depth image on the x-axis, DepthRateY is a ratio of the preset depth of field to the depth range of the initial depth image on the y-axis, and Dmax is a maximum depth value and D min is a minimum depth value of the initial depth image;
determining Pos_x and Pos_y according to formulas:
$$\begin{matrix}Pos\_x = x + ( {I}_{d} ( x , y ) - D min ) * DepthRateX + nx 0 , \\ Pos\_y = y + ( {I}_{d} ( x , y ) - D min ) * DepthRateY + ny 0 ; and\end{matrix}$$
determining the first color image and the target depth image according to formulas:
$$\begin{matrix}{I}_{c 1} ( Pos\_x , Pos\_y ) = {I}_{c} ( x , y ) , and \\ {I}_{d 2} ( Pos\_x , Pos\_y ) = {I}_{d} ( x , y ) ,\end{matrix}$$
wherein I_{c} is the initial color image, I_{c1} is the first color image, I_{c}(x, y) is a pixel value of a pixel with coordinate values (x, y) in the initial color image, I_{c1}(Pos_x, Pos_y) is a pixel value of a pixel with coordinate values (Pos_x, Pos_y) in the first color image, la is the initial depth image, I_{d2} is the target depth image, and I_{d2}(Pos_x, Pos_y) is a depth value of a pixel with coordinate values (Pos_x, Pos_y) in the target depth image.

9. A computer device, comprising:
a memory storing program codes; and
a processor configured to call the program codes in the memory to execute a 3D image generating method comprising:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

10. The computer device according to claim 9, wherein the determining the hole filling values of the target pixels according to the reference pixels comprises:
setting preset paths of traversing the reference pixels, wherein the preset paths are set in the target depth image;
traversing the preset paths based on coordinate values of the reference pixels, and determining a first target pixel and a second target pixel that meet a preset condition; and
determining the hole filling values according to coordinate values of the first target pixel and coordinate values of the second target pixel.

11. The computer device according to claim 10, wherein the determining the hole filling values according to the coordinate values of the first target pixel and the coordinate values of the second target pixel comprises:
in responding to that a depth value of the first target pixel is less than a depth value of the second target pixel, taking a pixel value of a pixel in the first color image as a hole filling value, wherein coordinate values of the pixel in the first color image are same as the coordinate values of the first target pixel; or
in responding to that a depth value of the first target pixel is greater than or equal to a depth value of the second target pixel, taking a pixel value of a pixel in the first color image as a hole filling value, wherein coordinate values of the pixel in the first color image are same as the coordinate values of the second target pixel.

12. The computer device according to claim 9, wherein the determining the target pixels according to the depth values of the reference pixels comprises:
in a condition that I_{d2}(x, y)≤0 is met, determining that a pixel with coordinate values (x, y) in the first color image is a target pixel which is a hole, wherein I_{d2} is the target depth image, I_{d2}(x, y) is a depth value of a reference pixel with coordinate values (x, y) in the target depth image.

13. The computer device according to claim 9, wherein the performing associative processing on the initial color image and the initial depth image to obtain the first color image and the target depth image comprises:
determining an initial point cloud corresponding to a first depth image, wherein the first depth image is obtained by remapping of the initial depth image;
adjusting coordinate values of each point in the initial point cloud according to a preset relative displacement to obtain a target point cloud;
processing coordinate values of each point in the target point cloud to obtain a reference image, wherein the reference image is a depth image that matches a size of the initial depth image;
processing pixels in the initial color image and pixels in the initial depth image according to depth values of pixels in the reference image to obtain the first color image and the target depth image.

14. The computer device according to claim 13, wherein the reference image are determined according to formulas:
$$\begin{matrix}Z ( x , y ) = min ( Z ( IP . x + 1 , IP . y + 1 ) , FltErr ) ; \\ FltErr = A - w / ( 2 * z 0 ) ; \\ IP = LP + Dis * DLP ; \\ Dis = ( PP - LP ) * PN ; and \\ DLP = - LP ,\end{matrix}$$
wherein Z is the reference image, Z(x, y) is a depth value of a pixel with coordinate values (x, y) in the reference image, Z(IP.x+1, IP.y+1) is a depth value of a pixel with coordinate values (IP.x+1, IP.y+1) in the reference image, and min means to assign Z(x, y) with a smaller one of Z(IP.x+1, IP.y+1) and FltErr,
LP=(x0, y\vec{0}, z0), PN=(0, \vec{0}, 1), PP=(0, \vec{0}, w/2), A is an initial depth value of the reference image, W is a width of the first depth image, (x0, y0, z0) are coordinate values of any point in the target point cloud, IP.x is an x-value of coordinate values of a point IP, and IP.y is a y-value of the coordinate values of the point IP.

15. The computer device according to claim 14, wherein the initial color image is processed to obtain the first color image according to a formula:
$${I}_{c 1} ( IP . x , IP . y ) = {I}_{c} ( x , y ) * ( ( Z ( x , y ) + 1 ) > FltErr ) ,$$
wherein I_{c} is the initial color image, I_{c1} is the first color image, I_{c}(x, y) is a pixel value of a pixel with coordinate values (x, y) in the initial color image, and Z(x, y) is the depth value of the pixel with the coordinate values (x, y) in the reference image. I_{c1}(IP.x, IP.y) is a pixel value of a pixel with coordinate values (IP.x, IP.y) in the first color image; and
the initial depth image is processed to obtain the target depth image according to a formula:
$${I}_{d 2} ( IP . x , IP . y ) = {I}_{d} ( x , y ) * ( ( Z ( x , y ) + 1 ) > FltErr ) ,$$
wherein I_{d} represents the initial depth image, I_{d2} represents the target depth image, I_{d}(x, y) is a depth value of a pixel with coordinate values (x, y) in the initial depth image, I_{d2}(IP.x, IP.y) is a depth value of a pixel with coordinate values (IP.x, IP.y) in the target depth image.

16. The computer device according to claim 1, wherein the performing associative processing on the initial color image and the initial depth image to obtain a first color image and a target depth image, wherein the target depth image comprises a plurality of reference pixels comprises:
determining a preset depth of field of the target 3D image, the preset depth of field of the target 3D image on an x-axis being nx0 to nx1, and the preset depth of field on the y-axis being ny0 to ny1;
determining a ratio of the preset depth of field to a depth range of the initial depth image according to formulas:
$$\begin{matrix}DepthRateX = ( nx 1 - nx 0 ) / ( D max - D min ) , and \\ DepthRateY = ( ny 1 - ny 0 ) / ( D max - D min ) ,\end{matrix}$$
wherein DepthRateX is a ratio of the preset depth of field to the depth range of the initial depth image on the x-axis, DepthRateY is a ratio of the preset depth of field to the depth range of the initial depth image on the y-axis, and Dmax is a maximum depth value and D min is a minimum depth value of the initial depth image;
determining Pos_x and Pos_y according to formulas:
$$\begin{matrix}Pos\_x = x + ( {I}_{d} ( x , y ) - D min ) * DepthRateX + nx 0 , \\ Pos\_y = y + ( {I}_{d} ( x , y ) - D min ) * DepthRateY + ny 0 ; and\end{matrix}$$
determining the first color image and the target depth image according to formulas:
$$\begin{matrix}{I}_{c 1} ( Pos\_x , Pos\_y ) = {I}_{c} ( x , y ) , and \\ {I}_{d 2} ( Pos\_x , Pos\_y ) = {I}_{d} ( x , y ) ,\end{matrix}$$
wherein I_{c} is the initial color image, I_{c1} is the first color image, I_{c}(x, y) is a pixel value of a pixel with coordinate values (x, y) in the initial color image, I_{c1}(Pos_x, Pos_y) is a pixel value of a pixel with coordinate values (Pos_x, Pos_y) in the first color image, la is the initial depth image, I_{d2} is the target depth image, and I_{d2}(Pos_x, Pos_y) is a depth value of a pixel with coordinate values (Pos_x, Pos_y) in the target depth image.

17. A non-transitory storage medium storing program codes, wherein when the program codes are invoked by a processor, a 3D image generating method comprising operations are realized:
separating a target 2D image to obtain an initial color image and an initial depth image;
performing associative processing on the initial color image and the initial depth image to obtain a first color image and a target depth image, wherein the target depth image comprises a plurality of reference pixels;
determining target pixels according to depth values of the reference pixels, wherein the target pixels are pixels that are holes in the first color image;
determining hole filling values of the target pixels according to the reference pixels, filling the target pixels, and generating a target color image; and
interleaving the initial color image and the target color image to generate a target 3D image.

18. The non-transitory storage medium according to claim 17, wherein the determining the hole filling values of the target pixels according to the reference pixels comprises:
setting preset paths of traversing the reference pixels, wherein the preset paths are set in the target depth image;
traversing the preset paths based on coordinate values of the reference pixels, and determining a first target pixel and a second target pixel that meet a preset condition; and
determining the hole filling values according to coordinate values of the first target pixel and coordinate values of the second target pixel.

19. The non-transitory storage medium according to claim 18, wherein the determining the hole filling values according to the coordinate values of the first target pixel and the coordinate values of the second target pixel comprises:
in responding to that a depth value of the first target pixel is less than a depth value of the second target pixel, taking a pixel value of a pixel in the first color image as a hole filling value, wherein coordinate values of the pixel in the first color image are same as the coordinate values of the first target pixel; or
in responding to that a depth value of the first target pixel is greater than or equal to a depth value of the second target pixel, taking a pixel value of a pixel in the first color image as a hole filling value, wherein coordinate values of the pixel in the first color image are same as the coordinate values of the second target pixel.

20. The non-transitory storage medium according to claim 17, wherein the determining the target pixels according to the depth values of the reference pixels comprises:
in a condition that I_{d2}(x, y)≤0 is met, determining that a pixel with coordinate values (x, y) in the first color image is a target pixel which is a hole, wherein I_{d2} is the target depth image, I_{d2}(x, y) is a depth value of a reference pixel with coordinate values (x, y) in the target depth image.
